(19) United States
(12) Patent Application Publication
(10) Pub. No.: US 2026/0169776 A1
(43) Pub. Date: Jun. 18, 2026

(54) DATA STORE IMPERSONATION SYSTEMS AND METHODS

(71) Applicant: The Bank of New York Mellon, New York, NY (US)

(72) Inventors: Steven Scagnelli, Lake Mary, FL (US); Wendy Liu, New York, NY (US)

(73) Assignee: The Bank of New York Mellon, New York, NY (US)

(21) Appl. No.: 18/978,246

(22) Filed: Dec. 12, 2024

(51) Int. Cl. G06F 9/455

(52) U.S. Cl. CPC G06F 9/45558; G06F 2009/45562

(57) ABSTRACT

Systems and methods to impersonate a core data store hosted on a core data store server include one or more virtual machines hosting data store clones, each comprising a portion of data from the core data store, intercept modules to replicate application programming interface functions of data store technology associated with the core data store, a data store conductor, a processor, a memory component, and machine-readable instructions. The instructions cause the system to intercept, via the intercept modules, action requests from a front end application transmitted to the core data store, queue the action requests to form an action request queue, transmit the action request queue to the data store conductor, and perform actions based on the action request queue on a portion of the data store clones.

### TECHNICAL FIELD

The present specification generally relates to data store impersonation systems, and more particularly, to systems and methods to impersonate a core data store hosted on a core data store server and that may be used for retroactive and transparent segmentation of large data stores such as for data store recovery.

### BACKGROUND

With an increasing number and size of data stores in various domains, a growing need exists for efficient restoration of backup. In particular, a need exists for efficient methods of recovering data stores in the order in which they are needed.

### SUMMARY

According to the subject matter of the present disclosure, a system to impersonate a core data store hosted on a core data store server may include one or more virtual machines hosting one or more data store clones, wherein each data store clone comprises at least a portion of data from the core data store; one or more intercept modules configured to replicate application programming interface functions of data store technology associated with the core data store; a data store conductor communicatively coupled to the one or more intercept modules and the one or more virtual machines; and a processor communicatively coupled to the data store conductor; a memory component communicatively coupled to the processor. The system may further include one or more machine readable instructions stored in the memory component that cause the system to perform at least the following when executed by the processor: intercept, via the one or more intercept modules, one or more action requests from a front end application transmitted to the core data store; queue the one or more action requests to form an action request queue; transmit the action request queue to the data store conductor; and perform one or more actions based on the action request queue on at least a portion of the one or more data store clones.

According to another embodiment of the present disclosure, a computer-implemented method for impersonating a core data store hosted on a core data store server may include intercepting, via one or more intercept modules, one or more action requests from a front end application transmitted to the core data store. The one or more intercept modules may be configured to replicate application programming interface functions of data store technology associated with the core data store. The computer-implemented method may further include queueing the one or more action requests to form an action request queue; and transmitting the action request queue to a data store conductor. The data store conductor may be communicatively coupled to the one or more intercept modules and one or more virtual machines. The computer-implemented method may further include performing one or more actions based on the action request queue on at least a portion of one or more data store clones. One or more virtual machines may host the one or more data store clones, and each data store clone may include at least a portion of data from the core data store.

According to yet another embodiment of the present disclosure, a computer-implemented method for impersonating a core data store hosted on a core data store server may include intercepting, via one or more intercept modules, one or more action requests from a front end application transmitted to the core data store, wherein the one or more intercept modules are configured to replicate application programming interface functions of data store technology associated with the core data store; queueing the one or more action requests to form an action request queue; transmitting the action request queue to a data store conductor, wherein the data store conductor is communicatively coupled to the one or more intercept modules and one or more virtual machines; and performing one or more actions based on the action request queue on at least a portion of one or more data store clones, wherein one or more virtual machines host the one or more data store clones, and each data store clone comprises at least a portion of data from the core data store. The computer-implemented method may further include generating a data map comprising a schema of the core data store to create each data store clone and each virtual machine hosting each data store clone; on an iterative schedule, creating a new virtual machine of the one or more virtual machines; creating a new data store clone of the one or more data store clones based on a blank data store schema, the new data store clone hosted on the new virtual machine; populating the new data store clone based on at least a most recent portion of data from the core data store; and decreasing computing resources allocated to the one or more virtual machines using older data while increasing computing resources to the new virtual machine over time.

The additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals in which:

FIG. 1 schematically depicts a system for data store impersonation, according to one or more embodiments shown and described herein;

FIG. 2 schematically depicts a system diagram of the system for data store impersonation of FIG. 1, according to one or more embodiments shown and described herein;

FIG. 3 schematically depicts an expanded view of one or more data store virtual machine server clones of FIG. 2, according to one or more embodiments shown and described herein; and

FIG. 4 schematically depicts an illustrative flowchart of a computer-implemented method for implementing the data store impersonation system of FIG. 1, according to one or more embodiments shown and described herein.

### DETAILED DESCRIPTION

Many businesses and other organizations rely on large data stores for their operations. Typically, a primary data store will be used for operations, and the data on the primary data store will be periodically backed up to a backup data store. If an event occurs causing loss of data from the primary data store, the data can be retrieved from the backup data store. However, as data stores continue to grow in size and complexity, recovering all of the data from the backup data store can be a difficult and time-consuming process. Furthermore, because data stores are typically monolithic, operations typically cannot be resumed until the entire data store is recovered from the backup data store. This can lead to system down-time during the recovery process.

In embodiments disclosed herein, a data store impersonation system clones a core data store as a plurality of virtual machines. A resource conductor manages the cloned data store by periodically creating new virtual machines, with each virtual machine storing a portion of data thereon. The mostly recently created virtual machine stores newly created records, while older virtual machines store older records.

When an action request is sent from a front end application to the core data store, the action request may be intercepted by an intercept module. A data store conductor may then identify the virtual machine containing the data on which the action request is to be performed, and perform the action request on the identified virtual machine. As such, if an event occurs requiring data recovery, the data from the most recently created virtual machines, which comprises the most recent data, can be recovered first. Because only a small portion of data is stored on each virtual machine, this recovery can be done quickly, and access can be restored to the most recent data without significant downtime. The data from the older virtual machines, which comprises older data, can be recovered more slowly. However, because older data is accessed less frequently, this will create less of a disruption. Therefore, the disclosed data store impersonation system allows for a quicker recovery of data from data stores in the event of an event that requires data recovery.

Embodiments of the present disclosure are thus directed to data store impersonation systems and computer-implemented methods of implementing data store impersonation, as will now be described in more detail herein with reference to the drawings and where like numbers refer to like structures.

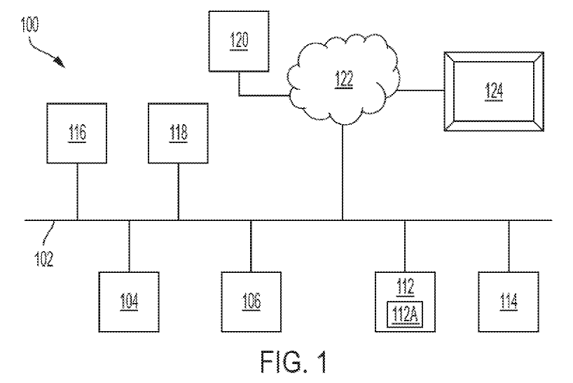

Referring now to FIG. 1, an embodiment of a system 100 for data store impersonation and recovery as described herein includes a communication path 102, one or more processors 104, a memory component 106, a data store impersonation module 112, a scheduling sub-module 112A of the data store impersonation module 112, one or more data stores 114, a data store access module 116, a network interface hardware 118, a network 122, a server 120, and a device 124, such as a computing device. The various components of the system 100 and the interaction thereof will be described in detail below.

While only one server 120 and one device 124 is illustrated in FIG. 1, the system 100 can comprise multiple servers containing one or more applications and/or computing devices. In some embodiments, the system 100 is implemented using a wide area network (WAN) or network 122, such as an intranet or the internet. The device 124 may include digital systems and other devices permitting connection to and navigation of the network 122. It is contemplated and within the scope of this disclosure that the device 124 may be a personal computer, a laptop device, a smart mobile device such as a smart phone or smart pad, or the like. Other system 100 variations allowing for communication between various geographically diverse components are possible. The lines depicted in FIG. 1 indicate communication rather than physical connections between the various components.

The system 100 includes the communication path 102. The communication path 102 may be formed from any medium that is capable of transmitting a signal such as, for example, conductive wires, conductive traces, optical waveguides, or the like, or from a combination of mediums capable of transmitting signals. The communication path 102 communicatively couples the various components of the system 100. As used herein, the term “communicatively coupled” means that coupled components are capable of exchanging data signals with one another such as, for example, electrical signals via conductive medium, electromagnetic signals via air, optical signals via optical waveguides, and the like.

The system 100 of FIG. 1 also includes the one or more processors 104. Each processor 104 can be any device capable of executing machine-readable instructions. Accordingly, each processor 104 may be a controller, an integrated circuit, a microchip, a computer, or any other computing device. Each processor 104 is communicatively coupled to the other components of the system 100 by the communication path 102. Accordingly, the communication path 102 may communicatively couple any number of processors 104 with one another, and allow the modules coupled to the communication path 102 to operate in a distributed computing environment. Specifically, each of the modules can operate as a node that may send and/or receive data.

The system 100 may further include the memory component 106 which is coupled to the communication path 102 and communicatively coupled to a processor 104 of the one or more processors 104. The memory component 106 may be a non-transitory computer readable medium or non-transitory computer readable memory and may be configured as a nonvolatile computer readable medium. The memory component 106 may include RAM, ROM, flash memories, hard drives, or any device capable of storing machine-readable instructions such that the machine-readable instructions can be accessed and executed by the processor 104. The machine-readable instructions may include logic or algorithm(s) written in any programming language such as, for example, machine language that may be directly executed by the processor 104, or assembly language, object-oriented programming (OOP), scripting languages, microcode, etc., that may be compiled or assembled into machine-readable instructions and stored on the memory component 106. Alternatively, the machine-readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIG. 1, as noted above, the system 100 may include a display, such as a graphical user interface (GUI), on a screen of the device 124 for providing visual output such as, for example, information, graphical reports, messages, or a combination thereof. The display on the screen of the device 124 is coupled to the communication path 102 and communicatively coupled to the processor 104. Accordingly, the communication path 102 communicatively couples the display to other modules of the system 100. The display can comprise any medium capable of transmitting an optical output such as, for example, a cathode ray tube, light emitting diodes, a liquid crystal display, a plasma display, or the like. Additionally, it is noted that the display or the device 124 can comprise at least one of the processor 104 and the memory component 106. While the system 100 is illustrated as a single, integrated system in FIG. 1, in other embodiments, the systems can be independent systems.

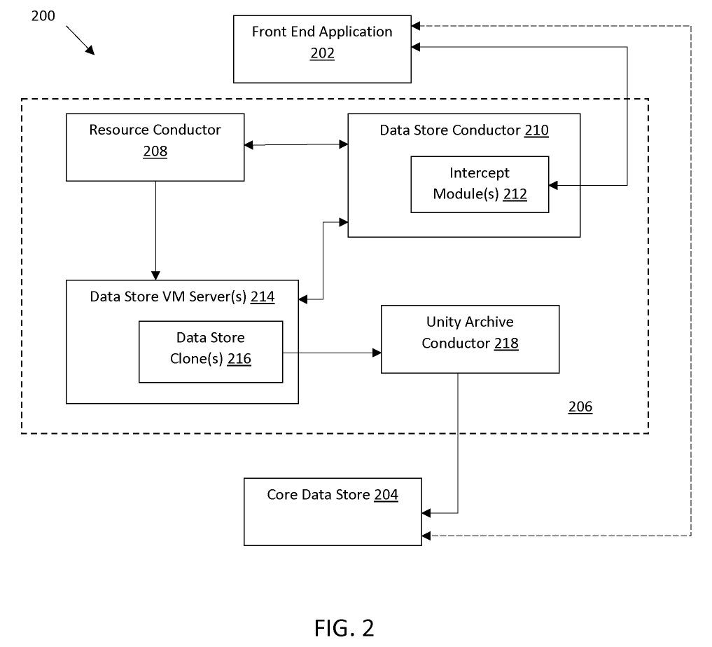

The system 100 may include the data store impersonation module 112 configured to at least impersonate a core data store 204 hosted on a core data store server 120, as will be described in greater detail further below, such as via communicatively coupled components described in system diagram 200 of FIG. 2. The scheduling sub-module 112A of the data store impersonation module 112 is configured to implement a schedule for the data store impersonation module 112 to follow to conduct functions such as generating data store clones and allocating computing resources to associated virtual machine servers as described in greater detail below. The data store access module 116 is configured to provide one or more action requests to and/or access the data store impersonation module 112 for information as described herein and in greater detail further below.

In embodiments, an artificial intelligence model may be employed by the systems and methods described herein, such as for the scheduling sub-module 112A to set the schedule, perform operations in real-time, and/or adjust any schedule implemented based on, for example, machine learning. Such a machine learning application may create models that can be applied by the system 100, to make it more efficient and intelligent in execution. As an example and not a limitation, the artificial intelligence model may include components such as an artificial intelligence engine, Bayesian inference engine, and a decision-making engine, and may have an adaptive learning engine further comprising a deep neural network learning engine and may include use of generative AI and small and large languages models or other types.

The data store impersonation module 112, the scheduling sub-module 112A, and the data store access module 116 are coupled to the communication path 102 and communicatively coupled to the processor 104. As will be described in further detail below, the processor 104 may process the input signals received from the system modules and/or extract information from such signals.

Data stored and manipulated in the system 100 as described herein is utilized by the data store impersonation module 112, which is able to leverage a cloud computing-based network configuration such as the cloud. Thus, the data store impersonation module 112 may be configured to provide stored data store information to entities and/or collaborator groups via a cloud network. The system 100 further includes the network interface hardware 118 for communicatively coupling the system 100 with a computer network such as network 122. The network interface hardware 118 is coupled to the communication path 102 such that the communication path 102 communicatively couples the network interface hardware 118 to other modules of the system 100. The network interface hardware 118 can be any device capable of transmitting and/or receiving data via a wireless network. Accordingly, the network interface hardware 118 can comprise a communication transceiver for sending and/or receiving data according to any wireless communication standard. For example, the network interface hardware 118 can comprise a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 1, data from various applications running on device 124 can be provided from the device 124 to the system 100 via the network interface hardware 118. The device 124 can be any device having hardware (e.g., chipsets, processors, memory, etc.) for communicatively coupling with the network interface hardware 118 and a network 122. Specifically, the device 124 can comprise an input device having an antenna for communicating over one or more of the wireless computer networks described above.

Referring still to FIG. 1, the network 122 can include any wired and/or wireless network such as, for example, wide area networks, metropolitan area networks, the internet, an intranet, satellite networks, or the like. Accordingly, the network 122 can be utilized as a wireless access point by the device 124 to access one or more servers (e.g., a server 120). In aspects, a server 120 may be a core data store server 120 and/or a data store virtual machine (VM) server 120 as described herein. The server 120 and any additional servers generally comprise processors, memory, and chipset for delivering resources via the network 122. Resources can include providing, for example, processing, storage, software, and information from the server 120 to the system 100 via the network 122. Additionally, it is noted that the server 120 and any additional servers can share resources with one another over the network 122 such as, for example, via the wired portion of the network, the wireless portion of the network, or combinations thereof. Where used herein, “a first element, a second element, or combinations thereof” reference an “and/or” combination similar to use herein of “at least one of a first element or a second element.”

Referring now to FIG. 2, a system diagram 200 of the system 100 of FIG. 1 for data store impersonation is depicted according to an embodiment. As shown in FIG. 2, the system diagram 200 includes system components for the system 100 including a front end application 202, a core data store 204, and a data store impersonation sub-system 206. The data store impersonation sub-system 206 is confirmed to impersonate the core data store 204 and to, for example, intercept messages being transmitted from the front end application 202 to the core data store 204 and/or transmit messages with data store information to the front end application 202 (that the core data store 204 would otherwise have submitted). The data store impersonation sub-system 206 includes a resource conductor 208, a data store conductor 210, one or more intercept modules 212, the one or more virtual machines (e.g., data store virtual machine (VM) servers) 214, one or more data store clones 216, and a unity archive conductor 218, which components are communicatively coupled. The resource conductor 208 is communicatively coupled to the data store conductor 210, and the unity archive conductor 218 may be communicatively coupled to the one or more data store clones 216.

The core data store 204 may be a data source such as a database hosted on a core data store server (e.g., a server 120 from FIG. 1) and may store data associated with a user application. The core data store 204 may store this data in a variety of formats (e.g., ORACLE, MS SQL, SYBASE). The core data store 204 can be used to satisfy regulatory requirements, such as by showing that all data for the user application is stored in one place. Furthermore, if necessary, the core data store 204 can be connected directly to the front end application 202 such that the front end application 202 may interact directly with the core data store 204. However, the core data store 204 can often be monolithic. Thus, in the case of an event, restoring all of the data from the core data store 204 can be difficult and time-consuming, which may result in significant down-time for the front end application 202, particularly in attempting to access the core data store 204. Accordingly, in embodiments disclosed herein, the core data store 204 is cloned into one or more data store clones 216 on a schedule (such as implementing by the scheduling sub-module 112A of FIG. 1) such that the front end application 202 may interact with the one or more data store clones 216 rather than directly with the core data store 204, as discussed in further detail below. In embodiments, the front end application 202 may interact with the one or more data store clones 216 while the core data store 204 utilizing the one or more data store clones 216, including one or more archived clones, to recover data during a system recovery after such an event.

The front end application 202 may be a user application including a user interface and that is configured to interact with data stored on the core data store 204. The front end application 202 may be associated with a variety of user applications. In aspects, the front end application 202 transmit action requests such as a request to retrieve records from the core data store 204, to update records in the core data store 204, and to add new records to the core data store 204.

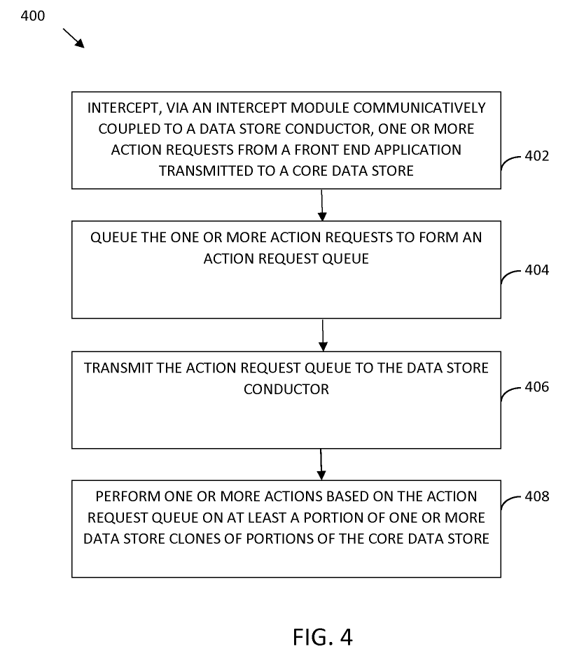

The front end application 202 may transmit such action requests to the core data store 204 to interact with the data stored thereon. As discussed above, in certain circumstances, the front end application 202 may be connected directly to the core data store 204. In these circumstances, the action requests transmitted by the front end application 202 may be received directly by the core data store 204. The core data store 204 may then perform one or more actions based on the action requests (e.g., adding, updating, or retrieving records), and may transmit a response and/or confirmation based on the performed action for the action request to the front end application 202. Embodiments herein are directed to a system 100 in which the front end application 202 avoids direct interaction with the core data store 204 and rather transmitted action requests are intercepted and performed by the data store impersonation sub-system 206 as described herein. As shown in FIGS. 1-2, the system diagram 200 for the system 100 (FIG. 1) to impersonate a core data store 204 hosted on a core data store server (e.g., a server 120 of FIG. 1) includes the data store impersonation sub-system 206, one or more virtual machines 214 (e.g., data store VM servers 214), the one or more intercept modules 212, the data store conductor 210, a processor 104, a memory component 106, and one or more machine readable instructions stored in the memory component 106 that cause the system 100 to perform one or more control schemes or processes as described herein (such as a process 400 of FIG. 4 described below) when executed by the processor 104. The one or more virtual machines 214 (e.g., the data store VM servers 214) host the one or more data store clones 216. Each data store clone includes at least a portion of data from the core data store 204. The one or more intercept modules 212 are configured to replicate application programming interface functions of data store technology associated with the core data store 204. In aspects, the data store technology may be associated with application programming interfaces for technologies such as ORACLE, MS SQL, SYBASE, and the like. The data store conductor 210 is communicatively coupled to the one or more intercept modules 212 and the one or more virtual machines 214. The processor 104 is communicatively coupled to the data store conductor 210, and the memory component 106 is communicatively coupled to the processor 104.

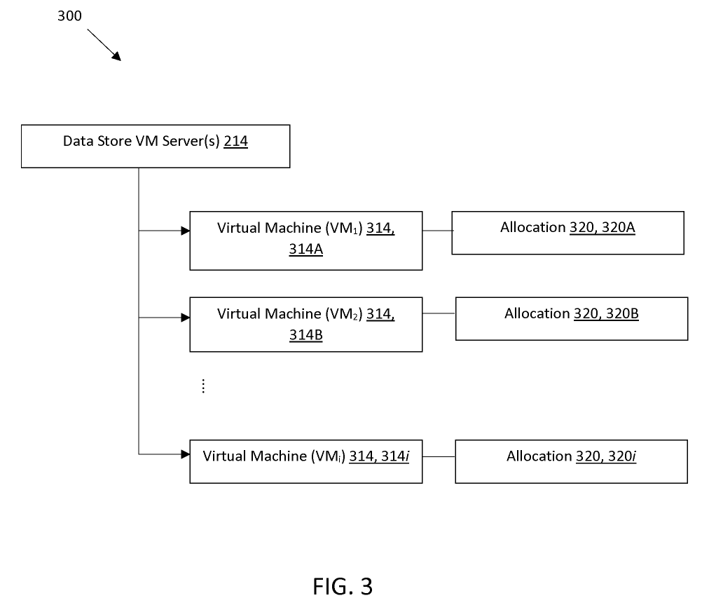

Referring to FIG. 3, a system diagram 300 depicts expanded system components of the data store VM servers 214 of FIG. 2, including a plurality of active virtual machines 314, each including an associated allocation 320 as described in greater detail below. Virtual machine (VM₁) 314A includes an allocation 320A, virtual machine (VM₂) 314B includes an allocation 320B, and so on until virtual machine (VMi) 314i includes an allocation 320i. In embodiments, i may be equal to three (3) such that three virtual machines are active as the data store VM servers 214 and allocated computing resources as allocations 320 at a given time and as described herein.

Referring to FIG. 4, a process 400 depicts a control scheme for implementation by the system 100 of FIG. 1 and following and using components of the system diagram 200 of FIG. 2. In embodiments, the one or more machine readable instructions stored in the memory component 106 cause the system to perform features of any control scheme described herein (such as the process 400) when executed by the processor.

Referring to FIGS. 2 and 4, in block 402 of FIG. 4, one or more action requests from the front end application 202 transmitted to the core data store 204 are intercepted via the one or more intercept modules 212 (FIG. 2). The one or more action requests may include (i) an action to update a record to form an updated record, (ii) an action to insert a record to form a new record, or (iii) an action to access a record of a portion of the one or more data store clones 216 on which an action is to be performed based on the action request. The action to update a record to form an updated record may be routed to a virtual machine of the one or more virtual machines 214 (e.g., the data store VM servers 214) hosting the data associated with the record to be updated. The action to insert a record to form a new record may be routed to a newest data store clone 216 on a newest virtual machine 214 of the one or more virtual machines 214.

Via the unity archive conductor 218, on an archive schedule, all new and updated records may be transmitted to the core data store 204. The core data store 204 may thus be updated based on the received new and updated records. The archive schedule may be set by the scheduling sub-module 112A (FIG. 1). The unity archive conductor 218 may update the core data store 204 on a periodic update schedule that may correspond to the archive schedule. As records are added or updated to the data store clones 216 maintained by the resource conductor 208, the records stored on the core data store 204 may begin to vary from the records stored across the data store clones 216. The unity archive conductor 218 may periodically update the core data store 204 such that the records stored on the core data store 204 match the records stored on the data store clones 216. The core data store 204 may thus stay up to date with the updates and additions to the data store clones 216.

In block 404, the one or more action requests are queued, such as by one or more intercept modules 212, to form an action request queue. In block 406, the action request queue is transmitted to the data store conductor 210 (e.g., by the one or more intercept modules 212).

In block 408, one or more actions are performed based on the action request queue on at least a portion of the one or more data store clones 216. The one or more actions may be performed by the data store impersonation sub-system 206 and/or other components of the system 100. In aspects, a catalog from the resource conductor 208 may be used to perform the one or more actions of block 408 on the at least a portion of the one or more data store clones 216. The catalog may be a catalog of the one or more data store clones 216 and respective associated data contained in each data store clone 216. The action request queue may be compared against the one or more data store clones 216 based on the catalog to identify the one or more data store clones 216 with relevant data as the at least a portion of the one or more data store clones 216 within which to perform the one or more actions in block 408.

In embodiments, a response may be generated based on performance of the one or more actions. The response may be generated as a single response for the action request queue by the data store conductor 210. The response may be transmitted to the front end application 202 (e.g., by the data store conductor 210) without involving a communication from the core data store 204 to the front end application 202.

In embodiments disclosed herein, the one or more data store clones 216 may thus impersonate the operations of the core data store 204. The one or more data store clones 216 may operate without the front end application 202 having knowledge of the existence or operations of any of the data store clone(s) 216. That is, the front end application 202 may continue to operate by transmitting commands or other requests to the core data store 204 and receiving responses from the one or more data store clones 216 that would otherwise have been received from the core data store 204 without an indication of the responses being sent from the one or more data store clones 216 rather than the core data store 204. As such, the one or more data store clones 216 may be added to an existing data store system (e.g., including the front end application 202 and core data store 204 that may be provided by a third party vendor) without the need to modify the architecture of or disrupt operations of the existing data store system (e.g., of the third party vendor).

Referring again to FIG. 2, the one or more machine readable instructions may cause the resource conductor 208 communicatively coupled to the data store conductor 210 to perform one or more control schemes or processes as described herein. In aspects, the resource conductor 208 may create the one or more virtual machines 214 hosting one or more data store clones 216 as well as the one or more data store clones 216 being hosted. As set forth herein, each data store clone 216 includes at least a portion of data from the core data store 204. The resource conductor 208 may, on a schedule, create a new virtual machine 214 hosting a new data store clone 216. Information including at least a name of the new virtual machine 214, a name of the new data store clone 216, and a date range covered in the new data store clone 216 may be communicated from the resource conductor 208 to the data store conductor 210. On a schedule, computing resources allocated to the one or more virtual machines 214 using older data may be decreased by the resource conductor 208 while the resource conductor 208 increases computing resources to the new virtual machine 214 over time. In aspects, the new data store clone 216 may be created based on a recent portion of records from the core data store 204. The new data store clone 216 may further may be directed by the data store conductor 210 to store newly created records, which new record addition requests may be received via an intercepted request from the front end application 202 as described herein.

When the resource conductor 208 creates a new virtual machine 214 and a new data store clone 216, the resource conductor 208 may use a data map to build each data store clone 216. The data map is configured to map data based on a schema between each data store clone 216 and the core data store. The data map may be used by the resource conductor 208 to build each data store clone. In an aspect, the data map may be stored on the resource conductor 208 and include a blank schema of the core data store 204 to build each new data store clone 216 hosted on a respective built new virtual machine 214. Information may be sent to each new data store clone 216 from the core data store 204 based on the data map and the blank schema. Further, a personal identification and keys data store stored on the resource conductor 208 may be used to tag information added to each new data store clone 216 with associated personal identification and keys information. The resource conductor 208 may maintain the personal identification and keys data store, as disclosed herein. The personal identification and keys data store may tag information added to each new data store clone 216 with associated personal identification (e.g., social security numbers) and other identifier/keys information. The personal identification and keys data store is configured to keep the smallest subset of data to identify an account owner locally such that queries for information contained therein do not require direct queries to the core data store 204. As such, if an event occurs and the core data store 204 is corrupted and/or inaccessible, such personal identification information can be quickly recovered directly from the resource conductor 208.

After a certain amount of time has passed, a schedule may call for the resource conductor 208 to create a new virtual machine 214 hosting a new data store clone 216. When such a creation occurs, the resource conductor 208 may update a catalog of virtual machines to indicate the date range covered by the previously created data store clone 216. Accordingly, when the front end application 202 transmits action requests to create new records on the core data store 204, these actions requests may be intercepted and routed to the newly created data store clone 216. Alternatively, when the front end application 202 transmits action requests to update or retrieve records of the core data store 204 that are covered by the date range associated with the previously created data store clone 216, these action requests may be intercepted and routed to the previously created data store clone 216 as described herein.

In embodiments, a data map may be generated, such as by the resource conductor 208, including a schema of the core data store 204 to create each data store clone 216 and each virtual machine 214 hosting each data store clone 216 by the resource conductor 208. On an iterative schedule, which may be directed by the scheduling sub-module 112A (FIG. 1), a new virtual machine 214 of the one or more virtual machines 214 may be created, and a new data store clone 216 of the one or more data store clones 216 may be created based on a blank data store schema and hosted on the new virtual machine 214. The new data store clone 216 may be populated based on at least a most recent portion of data from the core data store 204.

A catalog may be updated to indicate that one or more new records are to be stored on the new virtual machine 214, and a first request may be received as part of the action request queue to add a new record to the core data store 204. The new virtual machine 214 may be identified as the location where the one or more new records are to be stored by accessing the catalog (e.g., stored on the resource conductor 208 and accessed by the data store conductor 210). The new record may be then added (e.g., by direction of the data store conductor 210 and per the catalog) to the new data store clone 216 hosted on the new virtual machine 214.

The resource conductor 208 may further ensure that action requests to create new records are s routed to the most recently created data store clone 216, while action requests to access older records are routed to older data store clones 216 containing the relevant data. Because more recently created records tend to be accessed more frequently, if an event occurs, the more recently created data store clones 216 can be restored first, quickly restoring access to the more recent records by the front end application 202, and used to restore and recover a corresponding portion of data in the core data store 204. Older data store clones 216, storing older data, can be restored and used to restore the core data store 204 more slowly. However, because older data is accessed less frequently, this may lead to less down-time for the front end application 202 and a speedier system access recovery time. Furthermore, resource allocations to the various virtual machines 214 can be adjusted such that the system 100 operates more efficiently, as disclosed in further detail below in connection with FIG. 3.

Referring again to FIG. 3, on the schedule, computing resources allocated as allocations 320 to the one or more virtual machines 214 of the plurality of active virtual machines 314 using older data (e.g., virtual machines 314 B to virtual machine 314i having respective allocations 320B to 320i) may be decreased while computing resources allocated as allocations 320 may be increased to a new virtual machine 214 (e.g., virtual machine 314A having allocation 320A) of the plurality of active virtual machines 314 over time. In an embodiment, the one or more virtual machines 314B to 314i using the older data can include three active virtual machines 314 when i=3 and thus include a current data virtual machine 314B having allocation 320B and an older data virtual machine 314i having allocation 320i, and a new virtual machine (e.g., created on a schedule) is a new data virtual machine 314A having allocation 320A. A computing resource allocation 320A of 50% may be assigned (e.g., upon creation) to the new data virtual machine 314A, a computing resource allocation 320B of 100% may be assigned to the current data virtual machine 320B, and a computing resource allocation 320i of 25% may be assigned to the older data virtual machine 314i. The computing resource allocation 320A may be increased from 50% to 100% for the new data virtual machine 314A over time. The computing resource allocation 320B may be decreased from 100% to 50% for the current data virtual machine 314B over time. The computing resource allocation 320i may be decreased from 25% to a minimal percentage (i.e., 0% or slightly more than 0% to allow for computing access and which may be adjusted at a later time) for the older data virtual machine 314i over time. The older data virtual machine 314i may be archived (e.g., by the unity archive conductor 218 as described herein) when the current data virtual machine 314B replaces it as the older data virtual machine 314i (and the new data virtual machine 314A itself is replaced with a new virtual machine 214 and replaces the current data virtual machine 314B). Thus, the computing resource allocation 320B may be decreased from 50% to 25% for the current data virtual machine 314B over time, and, when a next new virtual machine 214 is created on the schedule, the next new virtual machine 214 becomes the new data virtual machine 314A, the previous new virtual machine 314A becomes the current data virtual machine 314B, and the previous current data virtual machine 314B becomes the older data virtual machine 314i

Thus, in an embodiment, a time period for the plurality of active virtual machines 314 to be cycled through with associated allocations 320 adjusted may be sliced into thirds. In a first slice of the time period, a new data virtual machine 314A may be moved to an allocation 320A of 75% while a current data virtual machine 314B is moved to an allocation 320B of 75%. In a second slice of the time period, the new data virtual machine 314A is moved to an allocation 320A of 100% and the current data virtual machine 314B is moved to an allocation 320B of 50%. Further, in a third slide period, another new created new data virtual machine 314A is set to an allocation 320A of 50%, the previously new data virtual machine 314A becomes the current data virtual machine 314B and is left at an associated allocation 320B of 100%, and the previous current data virtual machine 314B becomes an older data virtual machine 314i and an associated allocation 320i is dropped to 25% (from 50%).

While the above paragraphs describe particular allocations of computing resources for the active virtual machines 214, 314, it should be understood that these allocations are merely illustrative. In other examples, different allocations for the virtual machines may be assigned during the specified time periods after the creation of a new virtual machine 214, 314A. Furthermore, in other examples, the resource allocations of the virtual machines may be adjusted greater or fewer times than three in between creation of new virtual machines and/or more or less than three virtual machines 314 may be active at a time.

In embodiments, the system 100 for data store impersonation and associated methods as described herein further allow for efficient data recovery in the case of an event such as an attack on and resulting corruption of the core data store 204. In particular, by cloning the core data store 120, and spreading the data stored thereon across a plurality of data store clones 216 hosted on virtual machines 214, if data recovery is necessary, data can be initially be recovered from the data store clones 216 storing the most recent data. Because this data is likely to be accessed more often, recovering this data first minimizes system down-time as the most accessed data will be quickly recovered. Older data, which is not accessed as often, can then be recovered later, after the newer data has been recovered. While it may take longer to recover this older data, this data is accessed less often, and as such, this is less likely to cause significant down-time. Therefore, the embodiments described herein beyond allowing for a data store impersonation also provide for improved data recovery after an event.

It is also noted that recitations herein of “at least one” component, element, etc., should not be used to create an inference that the alternative use of the articles “a” or “an” should be limited to a single component, element, etc.

It is noted that recitations herein of a component of the present disclosure being "configured" or “programmed” in a particular way, to embody a particular property, or to function in a particular manner, are structural recitations, as opposed to recitations of intended use.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

### ASPECTS LISTING

Aspect 1. A system to impersonate a core data store hosted on a core data store server may include one or more virtual machines hosting one or more data store clones; one or more intercept modules; a data store conductor communicatively coupled to the one or more intercept modules and the one or more virtual machines; a processor communicatively coupled to the data store conductor; a memory component communicatively coupled to the processor; and one or more machine readable instructions stored in the memory component. Each data store clone may comprise at least a portion of data from the core data store. The one or more intercept modules may be configured to replicate application programming interface functions of data store technology associated with the core data store. The one or more machine-readable instructions may cause the system to perform at least the following when executed by the processor: intercept, via the one or more intercept modules, one or more action requests from a front end application transmitted to the core data store; queue the one or more action requests to form an action request queue; transmit the action request queue to the data store conductor; and perform one or more actions based on the action request queue on at least a portion of the one or more data store clones.

Aspect 2. The system of Aspect 1, wherein the one or more action requests comprise an action to update a record to form an updated record, an action to insert a record to form a new record, or an action to access a record of the portion of the one or more data store clones.

Aspect 3. The system of Aspect 2, wherein the action to update a record to form an updated record is routed to a virtual machine of the one or more virtual machines hosting the data associated with the record to be updated, and the action to insert a record to form a new record is routed to a newest data store clone on a newest virtual machine of the one or more virtual machines.

Aspect 4. The system of any of Aspect 1 to 3, further comprising a unity archive conductor communicatively coupled to the one or more data store clones, wherein the one or more machine readable instructions further cause the system to perform at least the following: via the unity archive conductor, on an archive schedule, transmit all new and updated records to the core data store; and update the core data store based on the received new and updated records.

Aspect 5. The system of any of Aspect 1 to 4, further comprising a resource conductor communicatively coupled to the data store conductor, wherein the one or more machine readable instructions further cause the system to perform at least the following: use a catalog from the resource conductor to perform the one or more actions on the at least a portion of the one or more data store clones by comparing the action request queue against the one or more data store clones based on the catalog to identify the one or more data store clones with relevant data as the at least a portion of the one or more data store clones within which to perform the one or more actions.

Aspect 6. The system of any of Aspect 1 to 5, wherein the one or more machine readable instructions further cause the system to perform at least the following: generate a response based on performance of the one or more actions; and transmit the response to the front end application without involving a communication from the core data store to the front end application.

Aspect 7. The system of any of Aspect 1 to 6, further comprising a resource conductor communicatively coupled to the data store conductor, wherein the one or more machine readable instructions further cause the resource conductor to perform at least the following: create, on a schedule, a new virtual machine hosting a new data store clone based on a recent portion of records from the core data store; communicate information comprising at least a name of the new virtual machine, a name of the new data store clone, and a date range covered in the new data store clone to the data store conductor; and decrease, on the schedule, computing resources allocated to the one or more virtual machines using older data while increasing computing resources to the new virtual machine over time.

Aspect 8. The system of Aspect 7, wherein a data map is configured to map data based on a schema between each data store clone and the core data store and is used by the resource conductor to build each data store clone.

Aspect 9. The system of Aspect 7 or Aspect 8, wherein the one or more virtual machines using the older data comprise a current data virtual machine and an older data virtual machine, and the new virtual machine comprises a new data virtual machine, and wherein the one or more machine readable instructions further cause the system to perform at least the following: assign a computing resource allocation of 50% to the new data virtual machine; assign a computing resource allocation of 100% to the current data virtual machine; assign a computing resource allocation of 25% to the older data virtual machine; increase the computing resource allocation of 50% to 100% for the new data virtual machine over time; and decrease the computing resource allocation of 100% to 50% for the current data virtual machine over time.

Aspect 10. The system of Aspect 9, wherein the one or more machine readable instructions further cause the system to perform at least the following: decrease the computing resource allocation of 50% to 25% for the current data virtual machine over time, wherein when a next new virtual machine is created on the schedule, the next new virtual machine becomes the new data virtual machine, the previous new virtual machine becomes the current data virtual machine, and the previous current data virtual machine becomes the older data virtual machine.

Aspect 11. The system of any of Aspect 7 to Aspect 10, wherein the one or more machine readable instructions further cause the system to perform at least the following: utilize a data map stored on the resource conductor and comprising a blank schema of the core data store to build each new data store clone hosted on a respective built new virtual machine; add information to each new data store clone from the core data store based on the data map and the blank schema; and utilize a personal identification and keys data store stored on the data store conductor to tag information added to each new data store clone with associated personal identification and keys information.

Aspect 12. The system of any of Aspect 1 to 11, further comprising a resource conductor communicatively coupled to the data store conductor, wherein the one or more machine readable instructions further cause the system to perform at least the following: generate a data map comprising a schema of the core data store to create each data store clone and each virtual machine hosting each data store clone.

Aspect 13. The system of Aspect 12, wherein the one or more machine readable instructions further cause the system to perform at least the following: on an iterative schedule, create a new virtual machine of the one or more virtual machines; create a new data store clone of the one or more data store clones based on a blank data store schema, the new data store clone hosted on the new virtual machine; and populate the new data store clone based on at least a most recent portion of data from the core data store.

Aspect 14. The system of Aspect 13, wherein the one or more machine readable instructions further cause the system to perform at least the following: update a catalog to indicate that one or more new records are to be stored on the new virtual machine; receive a first request as part of the action request queue to add a new record to the core data store; identify the new virtual machine as the location where the one or more new records are to be stored by accessing the catalog; and add the new record to the new data store clone hosted on the new virtual machine.

Aspect 15. A computer-implemented method for impersonating a core data store hosted on a core data store server, the computer-implemented method comprising: intercepting, via one or more intercept modules, one or more action requests from a front end application transmitted to the core data store, wherein the one or more intercept modules are configured to replicate application programming interface functions of data store technology associated with the core data store; queueing the one or more action requests to form an action request queue; transmitting the action request queue to a data store conductor, wherein the data store conductor is communicatively coupled to the one or more intercept modules and one or more virtual machines; and performing one or more actions based on the action request queue on at least a portion of one or more data store clones, wherein one or more virtual machines host the one or more data store clones, and each data store clone comprises at least a portion of data from the core data store.

Aspect 16. The computer-implemented method of Aspect 15, further comprising: via a unity archive conductor communicatively coupled to the one or more data store clones, on an archive schedule, transmitting all new and updated records to the core data store; and updating the core data store based on the received new and updated records.

Aspect 17. The computer-implemented of Aspect 15 or Aspect 16, further comprising: using a catalog from a resource conductor communicatively coupled to the data store conductor to perform the one or more actions on the at least a portion of the one or more data store clones by comparing the action request queue against the one or more data store clones based on the catalog to identify the one or more data store clones with relevant data as the at least a portion of the one or more data store clones within which to perform the one or more actions.

Aspect 18. The computer-implemented method of any Aspect 15 to 17, further comprising: creating, on a schedule, a new virtual machine hosting a new data store clone based on a recent portion of records from the core data store; communicating information comprising at least a name of the new virtual machine, a name of the new data store clone, and a date range covered in the new data store clone to the data store conductor; and decreasing, on the schedule, computing resources allocated to the one or more virtual machines using older data while increasing computing resources to the new virtual machine over time.

Aspect 19. The computer-implemented method of Aspect 18, further comprising: utilizing a data map stored on a resource conductor communicatively coupled to the data store conductor and comprising a blank schema of the core data store to build each new data store clone hosted on a respective built new virtual machine; adding information to each new data store clone from the core data store based on the data map and the blank schema; and utilizing a personal identification and keys data store stored on the resource conductor to tag information added to each new data store clone with associated personal identification and keys information.

Aspect 20. A computer-implemented method for impersonating a core data store hosted on a core data store server, the computer-implemented method comprising: intercepting, via one or more intercept modules, one or more action requests from a front end application transmitted to the core data store, wherein the one or more intercept modules are configured to replicate application programming interface functions of data store technology associated with the core data store; queueing the one or more action requests to form an action request queue; transmitting the action request queue to a data store conductor, wherein the data store conductor is communicatively coupled to the one or more intercept modules and one or more virtual machines; performing one or more actions based on the action request queue on at least a portion of one or more data store clones, wherein one or more virtual machines host the one or more data store clones, and each data store clone comprises at least a portion of data from the core data store; generating a data map comprising a schema of the core data store to create each data store clone and each virtual machine hosting each data store clone; on an iterative schedule, creating a new virtual machine of the one or more virtual machines; creating a new data store clone of the one or more data store clones based on a blank data store schema, the new data store clone hosted on the new virtual machine; populating the new data store clone based on at least a most recent portion of data from the core data store; and decreasing computing resources allocated to the one or more virtual machines using older data while increasing computing resources to the new virtual machine over time.

What is claimed is:

1. A system to impersonate a core data store hosted on a core data store server, the system comprising:
one or more virtual machines hosting one or more data store clones, wherein each data store clone comprises at least a portion of data from the core data store;
one or more intercept modules configured to replicate application programming interface functions of data store technology associated with the core data store;
a data store conductor communicatively coupled to the one or more intercept modules and the one or more virtual machines;
a processor communicatively coupled to the data store conductor;
a memory component communicatively coupled to the processor; and
one or more machine readable instructions stored in the memory component that cause the system to perform at least the following when executed by the processor:
intercept, via the one or more intercept modules, one or more action requests from a front end application transmitted to the core data store;
queue the one or more action requests to form an action request queue;
transmit the action request queue to the data store conductor; and
perform one or more actions based on the action request queue on at least a portion of the one or more data store clones.

2. The system of claim 1, wherein the one or more action requests comprise an action to update a record to form an updated record, an action to insert a record to form a new record, or an action to access a record of the portion of the one or more data store clones.

3. The system of claim 2, wherein the action to update a record to form an updated record is routed to a virtual machine of the one or more virtual machines hosting the data associated with the record to be updated, and the action to insert a record to form a new record is routed to a newest data store clone on a newest virtual machine of the one or more virtual machines.

4. The system of claim 1, further comprising a unity archive conductor communicatively coupled to the one or more data store clones, wherein the one or more machine readable instructions further cause the system to perform at least the following:
via the unity archive conductor, on an archive schedule, transmit all new and updated records to the core data store; and
update the core data store based on the received new and updated records.

5. The system of claim 1, further comprising a resource conductor communicatively coupled to the data store conductor, wherein the one or more machine readable instructions further cause the system to perform at least the following:
use a catalog from the resource conductor to perform the one or more actions on the at least a portion of the one or more data store clones by comparing the action request queue against the one or more data store clones based on the catalog to identify the one or more data store clones with relevant data as the at least a portion of the one or more data store clones within which to perform the one or more actions.

6. The system of claim 1, wherein the one or more machine readable instructions further cause the system to perform at least the following:
generate a response based on performance of the one or more actions; and
transmit the response to the front end application without involving a communication from the core data store to the front end application.

7. The system of claim 1, further comprising a resource conductor communicatively coupled to the data store conductor, wherein the one or more machine readable instructions further cause the resource conductor to perform at least the following:
create, on a schedule, a new virtual machine hosting a new data store clone based on a recent portion of records from the core data store;
communicate information comprising at least a name of the new virtual machine, a name of the new data store clone, and a date range covered in the new data store clone to the data store conductor; and
decrease, on the schedule, computing resources allocated to the one or more virtual machines using older data while increasing computing resources to the new virtual machine over time.

8. The system of claim 7, wherein a data map is configured to map data based on a schema between each data store clone and the core data store and is used by the resource conductor to build each data store clone.

9. The system of claim 7, wherein the one or more virtual machines using the older data comprise a current data virtual machine and an older data virtual machine, and the new virtual machine comprises a new data virtual machine, and wherein the one or more machine readable instructions further cause the system to perform at least the following:
assign a computing resource allocation of 50% to the new data virtual machine;
assign a computing resource allocation of 100% to the current data virtual machine;
assign a computing resource allocation of 25% to the older data virtual machine;
increase the computing resource allocation of 50% to 100% for the new data virtual machine over time; and
decrease the computing resource allocation of 100% to 50% for the current data virtual machine over time.

10. The system of claim 9, wherein the one or more machine readable instructions further cause the system to perform at least the following:
decrease the computing resource allocation of 50% to 25% for the current data virtual machine over time, wherein when a next new virtual machine is created on the schedule, the next new virtual machine becomes the new data virtual machine, the previous new virtual machine becomes the current data virtual machine, and the previous current data virtual machine becomes the older data virtual machine.

11. The system of claim 7, wherein the one or more machine readable instructions further cause the system to perform at least the following:
utilize a data map stored on the resource conductor and comprising a blank schema of the core data store to build each new data store clone hosted on a respective built new virtual machine;
add information to each new data store clone from the core data store based on the data map and the blank schema; and
utilize a personal identification and keys data store stored on the data store conductor to tag information added to each new data store clone with associated personal identification and keys information.

12. The system of claim 1, further comprising a resource conductor communicatively coupled to the data store conductor, wherein the one or more machine readable instructions further cause the system to perform at least the following:
generate a data map comprising a schema of the core data store to create each data store clone and each virtual machine hosting each data store clone.

13. The system of claim 12, wherein the one or more machine readable instructions further cause the system to perform at least the following:
on an iterative schedule, create a new virtual machine of the one or more virtual machines;
create a new data store clone of the one or more data store clones based on a blank data store schema, the new data store clone hosted on the new virtual machine; and
populate the new data store clone based on at least a most recent portion of data from the core data store.

14. The system of claim 13, wherein the one or more machine readable instructions further cause the system to perform at least the following:
update a catalog to indicate that one or more new records are to be stored on the new virtual machine;
receive a first request as part of the action request queue to add a new record to the core data store;
identify the new virtual machine as the location where the one or more new records are to be stored by accessing the catalog; and
add the new record to the new data store clone hosted on the new virtual machine.

15. A computer-implemented method for impersonating a core data store hosted on a core data store server, the computer-implemented method comprising:
intercepting, via one or more intercept modules, one or more action requests from a front end application transmitted to the core data store, wherein the one or more intercept modules are configured to replicate application programming interface functions of data store technology associated with the core data store;
queueing the one or more action requests to form an action request queue;
transmitting the action request queue to a data store conductor, wherein the data store conductor is communicatively coupled to the one or more intercept modules and one or more virtual machines; and
performing one or more actions based on the action request queue on at least a portion of one or more data store clones, wherein one or more virtual machines host the one or more data store clones, and each data store clone comprises at least a portion of data from the core data store.

16. The computer-implemented method of claim 15, further comprising:
via a unity archive conductor communicatively coupled to the one or more data store clones, on an archive schedule, transmitting all new and updated records to the core data store; and
updating the core data store based on the received new and updated records.

17. The computer-implemented method of claim 15, further comprising:
using a catalog from a resource conductor communicatively coupled to the data store conductor to perform the one or more action requests on the at least a portion of the one or more data store clones by comparing the action request queue against the one or more data store clones based on the catalog to identify the one or more data store clones with relevant data as the at least a portion of the one or more data store clones within which to perform the one or more action requests.

18. The computer-implemented method of claim 15, further comprising:
creating, on a schedule, a new virtual machine hosting a new data store clone based on a recent portion of records from the core data store;
communicating information comprising at least a name of the new virtual machine, a name of the new data store clone, and a date range covered in the new data store clone to the data store conductor; and
decreasing, on the schedule, computing resources allocated to the one or more virtual machines using older data while increasing computing resources to the new virtual machine over time.

19. The computer-implemented method of claim 18, further comprising:
utilizing a data map stored on a resource conductor communicatively coupled to the data store conductor and comprising a blank schema of the core data store to build each new data store clone hosted on a respective built new virtual machine;
adding information to each new data store clone from the core data store based on the data map and the blank schema; and
utilizing a personal identification and keys data store stored on the resource conductor to tag information added to each new data store clone with associated personal identification and keys information.

20. A computer-implemented method for impersonating a core data store hosted on a core data store server, the computer-implemented method comprising:
intercepting, via one or more intercept modules, one or more action requests from a front end application transmitted to the core data store, wherein the one or more intercept modules are configured to replicate application programming interface functions of data store technology associated with the core data store;
queueing the one or more action requests to form an action request queue;
transmitting the action request queue to a data store conductor, wherein the data store conductor is communicatively coupled to the one or more intercept modules and one or more virtual machines;
performing one or more actions based on the action request queue on at least a portion of one or more data store clones, wherein one or more virtual machines host the one or more data store clones, and each data store clone comprises at least a portion of data from the core data store;
generating a data map comprising a schema of the core data store to create each data store clone and each virtual machine hosting each data store clone;
on an iterative schedule, creating a new virtual machine of the one or more virtual machines;
creating a new data store clone of the one or more data store clones based on a blank data store schema, the new data store clone hosted on the new virtual machine;
populating the new data store clone based on at least a most recent portion of data from the core data store; and
decreasing computing resources allocated to the one or more virtual machines using older data while increasing computing resources to the new virtual machine over time.
